(19) United States
(12) Patent Application Publication
(10) Pub. No.: US 2006/0174279 A1
(43) Pub. Date: Aug. 3, 2006

(54) System and method for managing television tuners

(75) Inventors: Marc Andrew Sullivan, Austin, TX (US); Philip Ted Kortum, Austin, TX (US); James L. Cansler JR., Pflugerville, TX (US); Alyssa Lenorah Noll Williams, Elmhurst, IL (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 10/993,411

(22) Filed: Nov. 19, 2004

(51) Int. Cl. H04N 5/445; G06F 3/00; G06F 13/00

(52) U.S. Cl. 725/58; 725/38

(57) ABSTRACT

A method for managing a first television tuner and a second television tuner is provided. The method includes detecting when a channel request is received at the first television coupled to the first television tuner and detecting whether a recording is scheduled for the first television tuner. Thereafter, a user is queried via a second television to determine whether the second television tuner is available to record a scheduled recording.

### FIELD OF THE INVENTION

The present disclosure relates generally to the management of multiple television tuners within a single location.

### BACKGROUND

In order to recover television content received from a remote source, a television set top box has a television tuner. Once a particular channel is received (i.e., tuned), a user can watch the content of the channel in real time or a digital video recorder (DVR) within the set top box can record the content of the channel. As a result of this arrangement, there is an assigned tuner for each task that the set top box performs. For example, if a user wishes to watch one channel while recording another channel at the same time, the set top box would require at least two television tuners.

Television tuners are relatively expensive with respect to the total cost of a set top box, so it is beneficial to minimize the number of television tuners. During operation of a set top box, the number of desired actions may exceed the number of tuners required to perform the desired actions. In this event, the set top box will not be able to perform all of the desired actions. If a set top box includes two tuners and both tuners are assigned for use only at a single television, it is relatively easy to indicate to a user that the user's desired actions exceed the capability of the set top box. However, if multiple tuners of a set top box are assigned to different televisions in different rooms and multiple viewers are requesting actions that exceed the tuner imposed limitations of the set top box, there is increased difficulty in resolving tuner conflicts. Further, a typical home can include multiple set top boxes coupled to multiple televisions. Managing the television tuners in this environment has become increasingly difficult.

Accordingly, there is a need for an improved system and method for managing television tuners in a home entertainment system.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram of a first embodiment of a home entertainment system;

FIG. 2 is a block diagram of a second embodiment of a home entertainment system; and

FIG. 3 is a flow chart to illustrate a method of managing multiple tuners in a home entertainment system.

### DETAILED DESCRIPTION OF THE DRAWINGS

A method for managing a first television tuner and a second television tuner is provided. The method includes detecting when a channel request is received at the first television coupled to the first television tuner and detecting whether a recording is scheduled for the first television tuner. Thereafter, a user is queried via a second television to determine whether the second television tuner is available to record a scheduled recording.

When a recording is scheduled at the first tuner, an indication that a recording is scheduled is displayed at the first television. Further, a cancel recording option is presented at the first television. When the cancel recording option is selected, the schedule recording at the first tuner is cancelled. Also, the first television tuner is tuned to a requested channel. A send recording option can also be presented at the first television. When the send recording option is selected, an indication that a scheduled recording has been sent to the second tuner is presented at the second television. Further, a return recording option is presented at the second television.

When the return recording option is selected at the second television, an indication that the scheduled recording sent to the second television has been rejected is presented at the first television. Next, a cancel recording option is presented at the first television. If the cancel recording option is selected at the first television, the scheduled recording at the first tuner is cancelled. Thereafter, the first television tuner is tuned to a requested channel. Alternatively, when the scheduled recording sent to the second television is rejected, a watch recording option can be presented at the first television. When the watch recording option is selected, the first television tuner is tuned to a channel that is associated with the scheduled recording.

If no response is received from the second television, the scheduled recording is automatically transferred to the second tuner. Also, the second television tuner is tuned to a channel that is associated with the scheduled recording. Thereafter, the first television tuner can be tuned to a requested channel.

In addition to presenting a return recording option at the second television, a watch recording option can be presented at the second television when a scheduled recording is sent from the first television tuner. When the watch recording option is selected at the second television, the second television tuner is tuned to a channel that is associated with the scheduled recording. Then, the scheduled recording can be transferred to the second television tuner. The first television can be tuned to a requested channel.

In addition to presenting a cancel recording option and a send recording option at the first television when it is determined that a recording is scheduled at the first television tuner, a watch recording option can be presented at the first television. When the watch recording option is selected at the first television, the first television tuner is tuned to a channel that is associated with the scheduled recording.

In another embodiment, a home entertainment system is provided and includes a first television tuner and a second television tuner. A processor is coupled to the first television tuner and the second television tuner. Also, a memory device is accessible to the processor and a computer program is embedded within the memory device. The computer program includes instructions to detect when a channel request is received at a first television coupled to the first television tuner and instructions to detect whether a recording is scheduled for the television tuner for which the channel request is detected. Further, the computer program includes instructions to display a query at a second television that is coupled to the second television tuner in order to determine whether the second television tuner is available to record a scheduled recording.

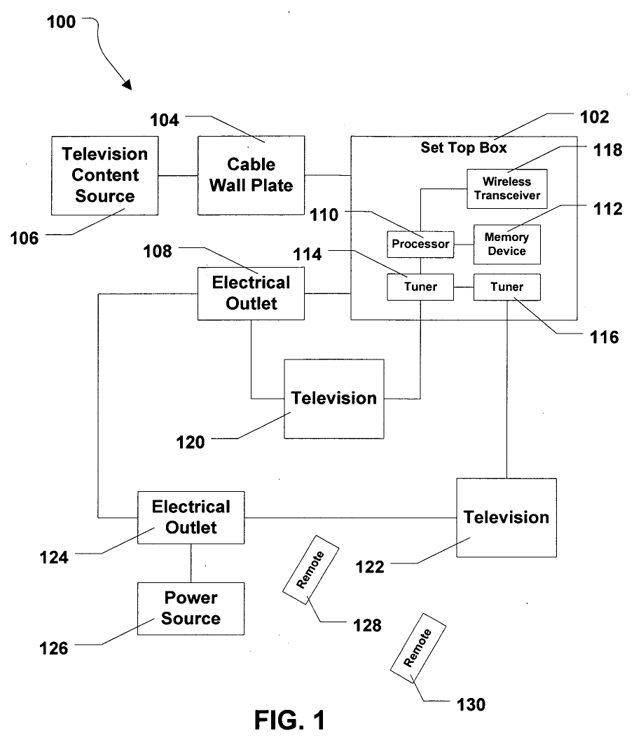

Referring to FIG. 1, a first embodiment of a home entertainment system is shown and is generally designated 100. As illustrated in FIG. 1, the home entertainment system 100 includes a set top box 102 that is coupled to a first broadband cable wall plate 104. The first broadband cable wall plate 104 is coupled to a television content source 106, e.g., a remote digital television content source. FIG. 1 also shows that the set top box is coupled to a first electrical outlet 108.

As depicted in FIG. 1, the set top box 102 can include a processor 110 and a memory device 112 that is coupled to the processor 110. Particularly, the processor 110 can access the memory device 112, for example, to read or write digital television content to and from the memory device 112. In an illustrative embodiment, the memory device 112 is a flash memory device or any other type of electronically erasable programmable read only memory (EEPROM) device or non-volatile memory device, such as a hard disk drive. Alternatively, the memory device 112 can be a RAM device. FIG. 1 further indicates that the set top box 102 includes a first television tuner 114 and a second television tuner 116. In a particularly embodiment, as indicated in FIG. 1, the set top box 102 includes two television tuners 114, 116, the set top box 102 can include more television tuners 114, 116 as needed.

FIG. 1 illustrates a first television 120 that is coupled to the first television tuner 114 and the first electrical outlet 108. A second television tuner 116 is coupled to the second television tuner and a second electrical outlet 124. The outlets 108, 124 are coupled to a power source 126. In a particular embodiment, each electrical outlet 108, 124 is a standard 110/120 volt alternating current (VAC) outlet. Moreover, as shown in FIG. 1, each electrical outlet 108, 124 is coupled to a power source 124, e.g., a 110/120 VAC power source. Also, the broadband cable wall plate 104 can include a coaxial cable connection, a category five (CAT-5) connection, a registered jack eleven (RJ-11) type connection, or a combination thereof.

FIG. 1 depicts a first remote control device 128 and a second remote control device 130. In a particular embodiment, the first remote control device 128 can communicate with the set top box 102 and the first television 120. Also, the second remote control device 130 can communicate with the set top box 102 and the second television 122. In an illustrative embodiment, the remote control devices 128, 130 can communicate using infrared (IR) signals or radio signals.

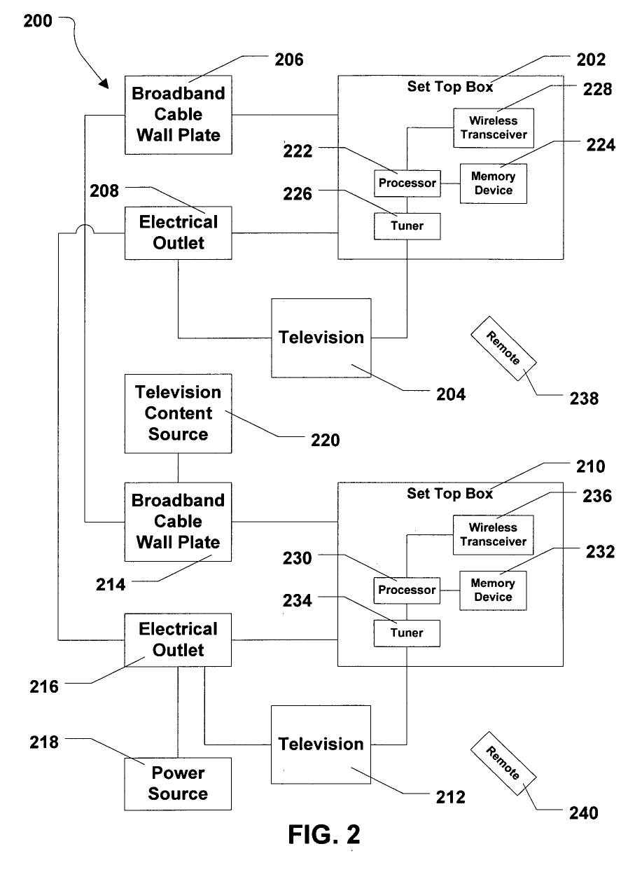

Referring now to FIG. 2, a second embodiment of a home entertainment system is shown and is generally designated 200. As illustrated in FIG. 2, the home entertainment system 200 includes a first set top box 202 that is coupled to a first television 204 and a first broadband cable wall plate 206. FIG. 2 shows that the first television 204 is also coupled to a first electrical outlet 208. Also, the first set top box 202 is coupled to the first electrical outlet 208.

FIG. 2 also shows a second set top box 210 that is coupled to a second television 212 and a second coaxial cable wall plate 214. FIG. 2 shows that the second television 212 is also coupled to a second electrical outlet 216. The second set top box 210 is also coupled to the second electrical outlet 216. In a particular embodiment, each electrical outlet 208, 216 is a standard 110/120 volt alternating current (VAC) outlet. Moreover, as shown in FIG. 2, each electrical outlet 208, 216 is coupled to a power source 218, e.g., a 110/120 VAC power source. Further, each broadband cable wall plate 206, 214 can include a coaxial cable connection, a category five (CAT-5) connection, a registered jack eleven (RJ-11) type connection, or a combination thereof. Additionally, each broadband cable wall plate 206, 214 can be coupled to each other and a television content source 220, e.g., a digital television content source.

As depicted in FIG. 2, the first set top box 202 can include a processor 222 and a memory device 224 that is coupled to the processor 222. FIG. 2 further indicates that the first set top box 202 includes a television tuner 226 that is coupled to the processor 222. Additionally, the first set top box 202 includes a wireless transceiver 228 that is coupled to the processor 222. FIG. 2 also indicates that the second set top box 210 can include a processor 230 and a memory device 232 that is coupled to the processor 230. FIG. 2 further indicates that the second set top box 210 includes a television tuner 234 that is coupled to the processor 230. Moreover, the second set top box 210 includes a wireless transceiver 236 that is coupled to the processor 230.

In a particular embodiment, within each set top box 202, 210, the processor 222, 230 can access the memory device 224, 232 for example, to read digital television content from and write digital television content to the memory device 224, 232. In an illustrative embodiment, each memory device 224, 232 is a flash memory device or any other type of electronically erasable programmable read only memory (EEPROM) device or other non-volatile memory device, such as a hard disk drive. In an alternative embodiment, each memory device 224, 232 can be a RAM device. In a particular embodiment, each wireless transceiver 228, 236 is a radio frequency (RF) transceiver, an ultra high frequency (UHF) transceiver, or an 802.11 Wi-Fi transceiver. Moreover, in a particular embodiment, during execution of the method described herein, the set top boxes 202, 210 can communicate with each other via the wireless transceivers 228 or via a broadband cable system.

FIG. 2 depicts a first remote control device 254 and a second remote control device 256. Particularly, the first remote control device 254 can communicate with the first set top box 202 and the first television 204. Also, the second remote control device 256 can communicate with the second set top box 212 and the second television 214. In an illustrative embodiment, the remote control devices 254, 256 can communicate using infrared (IR) signals.

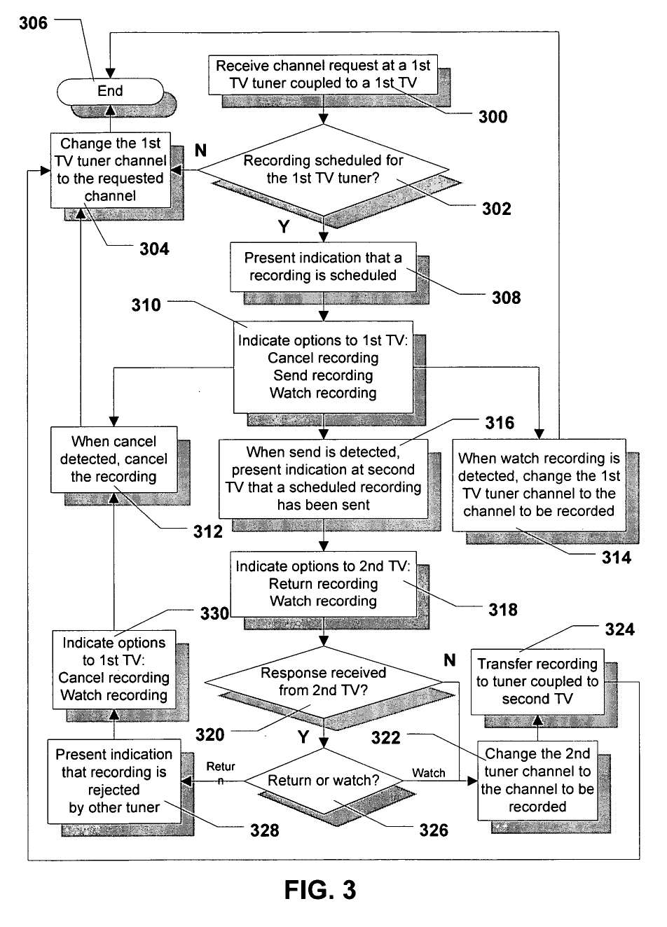

Referring now to FIG. 3, a method of managing multiple tuners in a home entertainment system is shown and commences at block 300 wherein the set top box receives a channel request for a first television tuner at a first television. Next, at block 302, the set top box determines whether a recording is scheduled for the first television tuner and whether the first television tuner is available to tune to the requested channel. If a recording is not scheduled, the method continues to block 304 and the set top box tunes the first television tuner channel to the requested channel. The logic then ends at state 306. Returning to decision step 302, when a recording is scheduled at the first television tuner, the method proceeds to block 308. At block 308, the set top box presents an indication, such as a display message, to a user of the first television that a recording is scheduled.

Proceeding to block 310, the set top box indicates several options to the user of the first television. In a particular embodiment, the options include: a cancel recording option, a send recording option, and a watch recording option. Further, in a particular embodiment, the options are presented to the user via a graphical user interface presented at the first television. The options are presented via a menu and the user can navigate the menu and select an option using a remote control device. At block 312, when the set top box detects the cancel recording option, the set top box cancels the previously schedule recording. Then, at block 304, the set top box tunes the first television tuner to the requested channel. The logic then ends at state 306. At block 314, when the set top box detects the selection of the watch recording option, the set top box tunes the first television tuner to the channel to be recorded. The logic then ends at state 306.

Moving to block 316, when the set top box detects the send option, the set top box presents an indication at the second television, e.g., by the displaying a text or graphic message, that a scheduled recording has been transferred to the second television. Thereafter, at block 318, the set top box provides a couple of options to the second television. In a particular embodiment, the options that are indicated to a user of the second television can include a return recording option and a watch recording option. Proceeding to decision step 320, the set top box determines whether a response is received from the second television. If no response is received, indicating that no one is watching the second television, the method continues to block 322 and the set top box tunes the second television tuner to the channel associated with the scheduled recording. Thereafter, at block 324, the set top box transfers the scheduled recording to the second television tuner. At block 304, the set top box then tunes the first television tuner channel to the requested channel. The method then ends at state 306.

Returning to decision step 320, if the set top box receives a response from the second television, the method moves to decision step 326 and the set top box determines whether the response is the return recording option or the watch recording option. If the set top box receives the watch recording option, the method proceeds to block 322 and the set top box tunes the second television tuner to the channel associated with the scheduled recording. Thereafter, at block 324, the set top box transfers the scheduled recording to the second television tuner. Then, at block 304, the set top box tunes the first television tuner channel to the requested channel. The method then ends at state 306.

Returning to decision step 326, if the set top box receives the return recording option from the second television, the method continues to block 328 and the set top box presents an indication to the first television that the scheduled recording has been rejected by the second television coupled to the second tuner. Next, at block 330, the set top box presents a couple of options to a user of the first television. In a particular embodiment, the options include a cancel recording option and a watch recording option. Moving to block 312, when the set top box detects the cancel recording option, the set top box cancels the scheduled recording. Then, at block 304, the set top box tunes the first tuner to the requested channel. The logic then ends at state 306. On the other hand, at block 314, when the set top box detects the watch recording option, the set top box tunes the first television tuner to the channel associated with the scheduled recording. The logic then ends at state 306.

With the configuration of structure described above, the system and method of managing television tuners provides efficient management of television tuner demand based on tuner availability.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for managing at least a first television tuner and at least a second television tuner, the method comprising:
detecting when a channel request is received at a first television coupled to the first television tuner;
detecting whether a recording is scheduled for the first television tuner; and
querying a user via a second television to determine if the second television tuner is available to record a scheduled recording.

2. The method of claim 1, further comprising indicating that a recording is scheduled at the first television tuner via the first television.

3. The method of claim 2, further comprising presenting a cancel recording option at the first television.

4. The method of claim 3, further comprising canceling a schedule recording when the cancel recording option is selected.

5. The method of claim 4, further comprising tuning the first television tuner to a requested channel.

6. The method of claim 2, further comprising presenting a send recording option at the first television.

7. The method of claim 6, further comprising indicating at the second television that a scheduled recording has been sent to the second tuner when the send recording option is selected.

8. The method of claim 7, further comprising presenting a return recording option at the second television.

9. The method of claim 8, further comprising indicating at the first television that the scheduled recording sent to the second television has been rejected.

10. The method of claim 9, further comprising presenting a cancel recording option at the first television.

11. The method of claim 10, further comprising canceling the scheduled recording when the cancel recording option is selected.

12. The method of claim 11, further comprising tuning the first television tuner to a requested channel.

13. The method of claim 12, further comprising presenting a watch recording option at the first television.

14. The method of claim 13, further comprising tuning the first television tuner to a channel associated with the scheduled recording.

15. The method of claim 7, further comprising transferring the scheduled recording to the second tuner when no response is received via the second television.

16. The method of claim 15, further comprising tuning the second television tuner to a channel associated with the scheduled recording.

17. The method of claim 16, further comprising tuning the first television tuner to a requested channel.

18. The method of claim 7, further comprising presenting a watch recording option at the second television.

19. The method of claim 18, further comprising tuning the second television tuner to a channel associated with the scheduled recording.

20. The method of claim 19, further comprising transferring the scheduled recording to the second television tuner.

21. The method of claim 20, further comprising tuning the first television tuner to a requested channel.

22. The method of claim 2, further comprising presenting a watch recording option at the first television.

23. The method of claim 22, further comprising tuning the first television tuner to a channel associated with the scheduled recording.

24. A home entertainment system comprising:
at least two television tuners comprising a first television tuner and a second television tuner;
a processor coupled to the first television tuner and the second television tuner;
a memory device accessible to the processor; and
a computer program embedded within the memory device, the computer program comprising:
instructions to detect when a channel request is received at a first television coupled to the first television tuner;
instructions to detect whether a recording is scheduled for the television tuner for which the channel request is detected; and
instructions to display a query at a second television coupled to the second television tuner to determine whether the second television tuner is available to record a scheduled recording.

25. The home entertainment system of claim 24, wherein the computer program further comprises instructions to display an indication at the first television that a recording is scheduled for the first television tuner.

26. The home entertainment system of claim 25, wherein the computer program further comprises instructions to display a cancel recording option at the first television.

27. The home entertainment system of claim 26, wherein the computer program further comprises instructions to cancel a schedule recording when the cancel recording option is selected.

28. The home entertainment system of claim 27, wherein the computer program further comprises instructions to tune the first television tuner to a requested channel.

29. The home entertainment system of claim 25, wherein the computer program further comprises instructions to display a send recording option at the first television.

30. The home entertainment system of claim 29, wherein the computer program further comprises instructions to display an indication at the second television that a scheduled recording has been sent to the second tuner when the send recording option is selected.

31. The home entertainment system of claim 30, wherein the computer program further comprises instructions to display a return recording option at the second television.

32. The home entertainment system of claim 31, wherein the computer program further comprises instructions to display an indication at the first television that a user at the second television has rejected the scheduled recording.

33. The home entertainment system of claim 32, wherein the computer program further comprises instructions to display a cancel recording option at the first television.

34. The home entertainment system of claim 33, wherein the computer program further comprises instructions to cancel the scheduled recording when the cancel recording option is selected.

35. The home entertainment system of claim 34, wherein the computer program further comprises instructions to tune the first television tuner to a requested channel.

36. The home entertainment system of claim 32, wherein the computer program further comprises instructions to display a watch recording option at the first television.

37. The home entertainment system of claim 36, wherein the computer program further comprises instructions to tune the first television tuner to a channel associated with the scheduled recording.

38. The home entertainment system of claim 30, wherein the computer program further comprises instructions to transfer the scheduled recording to the second tuner when no response is received.

39. The home entertainment system of claim 38, wherein the computer program further comprises instructions to tune the second television tuner to a channel associated with the scheduled recording.

40. The home entertainment system of claim 39, wherein the computer program further comprises instructions to tune the first television tuner to a requested channel.

41. The home entertainment system of claim 30, wherein the computer program further comprises instructions to display a watch recording option at the second television.

42. The home entertainment system of claim 41, wherein the computer program further comprises instructions to tune the second television tuner to a channel associated with the scheduled recording.

43. The home entertainment system of claim 42, wherein the computer program further comprises instructions to transfer the scheduled recording to the second television tuner.

44. The home entertainment system of claim 43, wherein the computer program further comprises instructions to tune the first television tuner to a requested channel.

45. The home entertainment system of claim 25, wherein the computer program further comprises instructions to indicate a watch recording option at the first television.

46. The home entertainment system of claim 45, wherein the computer program further comprises instructions to tune the first television tuner to a channel associated with the scheduled recording.
